(19) United States
(12) Patent Application Publication
(10) Pub. No.: US 2015/0104551 A1
(43) Pub. Date: Apr. 16, 2015

(54) BAKED COATINGS AND METHODS FOR APPLYING TO FOOD PRODUCTS

(71) Applicant: CARGILL, INCORPORATED, Wayzata, MN (US)

(72) Inventors: Jeffrey L. Casper, Minneapolis, MN (US); Matthew Arnold Gennrich, St. Louis Park, MN (US); Andrea Peck Moeller, St. Louis Park, MN (US)

(73) Assignee: Cargill, Incorporated, Wayzata, MN (US)

(21) Appl. No.: 14/403,784

(22) PCT Filed: May 31, 2013
(86) PCT No.: PCT/US2013/043598

§ 371 Date: Nov. 25, 2014

Related U.S. Application Data
(60) Provisional application No. 61/653,831, filed on May 31, 2012.

(51) Int. Cl. A23L 1/00; A23L 1/01

(52) U.S. Cl. CPC A23L 1/005; A23L 1/0055; A23L 1/01; A23V 2002/00
USPC 426/243; 426/293

(57) ABSTRACT

Systems and methods for producing a baked product that have the appearance, texture and/or flavor of fried foods are disclosed. In one embodiment, a method for producing a baked product that imparts fried food properties includes at least partially coating a food product with an oil product, combining a breading composition with the food product, applying water to the food product, and baking the food product. Aspects of the disclosure are particularly directed to a method of baking food products by providing a bread composition and process that imparts a deep fried texture and flavor without having to deep fat fry the food product, thereby reducing the fat content of the final food product and avoiding the need to use a fryer.

### CROSS REFERENCE TO RELATED APPLICATION

This application claims the benefit of the U.S. Provisional Patent Application Ser. No. 61/653,831, filed May 31, 2012, entitled BAKED COATINGS AND METHODS FOR APPLYING TO FOOD PRODUCTS, which is hereby incorporated by reference in its entirety.

### FIELD OF THE INVENTION

The present invention relates generally to coatings, used in baking methods, and for applying them to various food products that provide a fried appearance, texture, and flavor to foods. Aspects of the disclosure are particularly directed to a method of baking food products by providing a breading composition and process that imparts a deep-fried texture and flavor through a baking step without having to deep fat-fry the food product, thereby reducing the fat content of the final food product and avoiding the need to use a fryer.

### BACKGROUND OF THE INVENTION

There is a strong need in finding low calorie alternatives to the traditional method of making foods fried in oils and fats. In addition to adding high caloric value to foods, fried foods can increase health risks to people, including the potential of raising cholesterol levels. Frying foods in oils or fats, such as in a deep fat fryer, provides unique characteristics to foods—including the taste experience, as the foods have a crispy exterior texture that provides a “crunch” while maintaining a moist, or juicy, interior to the food. In addition, the exterior of fried foods has a particular color and appearance denoting that the food is fried. However, an unfortunate result of frying foods in oils and fats is the substantial increase in the caloric value added to the food product. In addition, makers of fried foods, such as cooks and restaurant operators, need separate equipment to be able to deep fry foods and therefore look for alternatives to this method.

The traditional method of frying foods includes coating the food product in a dry mixture (such as flour), dredging the food product in a liquid batter (such as egg and/or milk), adding a breading to the food product, and then putting the food product in a flying unit containing an oil and/or fat. After the food product has been cooked in the fryer for a period of time, the food product is removed from the fryer, slightly cooled, and eaten. After frying, the food product will have a crispy brown exterior. The interior of the food product will remain moist and tender, and the frying process allows the food to retain its flavor.

Alternative processes have been tried but have limitations. One process uses breadcrumbs which have been coated in oil and are then baked (in order to avoid soaking the entire food product in oil). However, the final food product does not have the traditional fried batter appearance, nor the same texture or flavor of fried foods. Another attempt at mimicking fried food properties is discussed in U.S. Pat. No. 3,843,827, entitled “Process for Baking Foodstuffs”, which discloses a process of using a batter comprised of raw egg and other liquid ingredients, coating the battered product with a dry mix of ingredients, then baking the product. However, the resulting product does not have the crisp texture and exterior of the traditional frying method. In addition, it has the disadvantage of using a microbiologically sensitive ingredient (with the eggs) in a product that is baked rather than fried.

Unfortunately, to date, there has not been a good substitute food/food ingredient, coating, or alternative process to reduce/replace the use of oils or fats to fry foods (and which would also provide the same properties and taste experience to the food product without the full fat content typical of deep fried foods). A need therefore exits for a healthier, and safer, alternative to the traditional process of frying foods; one which also imparts a similar appearance, texture, and flavor of fried foods without the need to use deep fat frying equipment.

### SUMMARY OF THE INVENTION

In view of the above, it is an object of the present invention to provide a baked food product that provides a fried food experience—without the issues associated with frying foods in oil or fat in a deep fat fryer. For instance, the present invention provides a lower calorie alternative to foods fried in fat or oil by allowing the food product to be “fried” through a baking step, without the need of a frying step. It provides a baked food product that imparts fried food qualities, such as a fried food appearance, texture, and/or flavor. The present invention further provides an alternative process that avoids having to use a deep fat fryer (or similar equipment) for cooking the food product. In an alternative embodiment, the food product can be frozen and then baked at a later time.

One embodiment is directed toward a method of producing a baked product that imparts fried food properties, comprising: at least partially coating a food product with an oil product, adding a breading composition to the food product, applying water to the food product, and baking the food product.

In a another embodiment, a method for producing a baked product produces the properties of a fried food, which comprises: providing a first breading composition to a food product, at least partially coating a food product with an oil product, adding a second breading composition to the food product, applying water to the food product, and baking the food product.

A further embodiment includes a method of producing a baked product that imparts properties of fried foods, comprising: at least partially coating a food product with an oil product, adding a breading composition to the food product, and baking the food product in a steam injection oven to produce a baked product. Use of a steam injection oven allows water to be applied to the food product at the same time that it is baked.

Another embodiment is directed toward a method of producing a frozen food product for baking that, when baked, produces properties of a fried food, including: at least partially coating a food product with an oil product, adding a breading composition to the food product, and freezing the food product. An alternative embodiment further comprises applying water to the food product. The food product can then be baked.

### BRIEF DESCRIPTION OF THE FIGURES

FIG. 1 shows the baked food products according to examples 1-7.

FIG. 2 shows the top 3 (best) and bottom 3 (worst) runs from example 8.

### DETAILED DESCRIPTION OF THE INVENTION SELECTED DEFINITIONS

As used herein, the following terms shall have the following meanings:

The term “baked product” as used herein is a product produced by the processes described in the present disclosure on any variety of food products.

The term “food product” as used herein is any food product for human consumption including, but not limited to: meat products, vegetables, seafood, edible fungi, or combinations thereof.

The term “oil product” as used herein is an oil, a fat, a water-in-oil emulsion, Olean, mono- and di-glycerides, or combinations thereof. Any number of oils can be used, including: vegetable, canola, peanut, sunflower, olive, walnut, safflower, corn, truffle, avocado, mustard, palm, rice bran, sesame, cottonseed, grape seed, rape seed, almond, or other oils. Fats can include lard, shortening, butter, margarine, or other animal-based fats. Water-in-oil emulsions can include any mixtures of water in an oil emulsion sufficient to allow the water to be appropriately mixed with the oil.

The term “breading composition” as used herein is a n-OSA starch, a cook-up starch, a pre-gelatinized starch, other glucose polymer, or combinations thereof. Pre-gelatinized starch can be derived from a variety of carbohydrates, including but not limited to: corn, waxy corn, potato, tapioca, or combinations thereof. Glucose polymers can include a number of different compounds such as dextrins, maltodextrins, native starches, carbohydrates, or combinations thereof. The breading composition can further include other ingredients, such as a browning agent, a farinaceous material, an oil product, a leavening agent, flavorings, or combinations thereof.

The breading composition is primarily made up of a main starch component. The term “main starch component”, as used herein means a blend of n-OSA starch, cook-up starch, and/or pre-gelatinized starch.

The term “n-OSA starch” as used herein refers to any starch, or combination of like starches, that has been chemically modified using n-octenyl succinic anhydride in order to provide the starch with lipophilic, or fat-binding, properties.

The term “cook-up starch” as used herein refers to any starch, or combination of like starches, that has not been pre-cooked (gelatinized) and therefore requires both heat and water to achieve their “cooked” characteristics (viscosity, texture & flavor profile, etc.).

The terms “pre-gelatinized starch” and/or “pregel starch” as used herein refer to any starch, or combination of like starches, that have been pre-cooked (gelatinized) and then re-dried into powder form in order to allow for these starches to achieve instant, or rapid, viscosity when rehydrated.

The term “browning agent” as used herein is a source of one or more of the following: reducing sugars, proteins, peptides, amino acids, and pH modifiers or any compound that results in a maillard reaction, or combinations thereof. Examples include: buttermilk powder, baking soda, dextrose, fructose, honey, Maillose, lactose, Nonfat Dry Milk, whey, caseinate, soy protein, soy flour.

The term “farinaceous material” as used herein is corn meal, wheat starch, wheat flour, rye flour, white/patent flour, whole grain flours including wheat flour, corn flour and rice flour, corn starch, soy flour, potato starch, potato flour, tapioca starch, tapioca flour, or combinations thereof.

The term “leavening agent” as used herein is yeast, buttermilk, yogurt, sourdough starter, sodium bicarbonate (also known as baking soda), baking powders, or combinations thereof.

The term “flavorings” as used herein can be any number of products used to add flavor to a food product, such as spices (which are derived from dried vegetables, flower buds, seeds, roots, or barks), and that include, but are not limited to: salt, pepper, pepper salt, white pepper, red pepper, black pepper, garlic salt, garlic powder, celery salt, onion salt, onion powder, paprika, chili powder, cinnamon, sage, fennel seed, oregano, tarragon and other spices. Flavorings can also include herbs, including but not limited to: rosemary, thyme, lavender, basil, dill weed, coriander, mint and other herbs. Some flavorings can also add color to the food product, such as paprika.

### GENERAL DESCRIPTION

The present invention relates generally to coatings used in baking methods for applying them to various food products that provide a fried appearance, texture, and/or flavor to foods. Aspects of the disclosure are particularly directed to a method of baking food products by providing a breading composition and process that imparts a deep fried texture and flavor through a baking step, without having to deep fat fry the food product, thereby reducing the fat content of the final food product and avoiding the need to use frying equipment.

One embodiment allows for a method of producing a baked product that imparts fried food properties, comprising: at least partially coating a food product with an oil product, adding a breading composition to the food product, applying water to the food product, and baking the food product. The oil product used to at least partially coat the food product can comprise any number of oil products known in the industry, such as an oil, a fat, a water-in-oil emulsion, Olean, mono- and di-glycerides, or combinations thereof.

The breading composition added to the food product can comprise a n-OSA starch, a cook-up starch, a pre-gelatinized starch, other glucose polymer, or combinations thereof. In one embodiment, the breading composition comprises a pre-gelatinized crisping starch, maltodextrin, or a combination thereof. In another embodiment, the maltodextrin is a low dextrose equivalent (DE) maltodextrin, preferably with a DE of 20 or below. In another embodiment, the maltodextrin has a DE of 10 or below. In a further embodiment, the DE of the maltodextrin is 5 or below. A final embodiment contains no maltodextrin, with the primary starch component of the breading comprised solely of varying levels of n-OSA, cook-up, and pregel starches.

The breading composition can further comprise any number of other ingredients, including: browning agents, farinaceous materials, oils, leavening agents, spices, flavorings, or combinations thereof. Depending on the food product to be baked and the desired color, a browning agent can be used to provide a darker color. Conversely, some food products, such as tempura-style foods, do not require any further browning and do not require a browning agent. The breading composition can further comprise an oil product as an ingredient. Finally, the breading composition can further comprise a leavening agent. The leavening agent allows the food product to “kernel” or “puff-up,” which helps to provide the fried food appearance.

The breading composition includes a main starch component. The main starch component is made up of a blend of n-OSA starch, cook-up starch, and/or pre-gelatinized starch. Applicants have surprisingly discovered that use of certain blends of n-OSA starch, cook-up starch, and/or pre-gelatinized starch which make up the main starch component of the breading composition lead to food products which possess certain sensory benefits. Such sensory benefits include improved crispiness as well as reduced toothpack, reduced aftertaste, and reduced gray nubs.

In certain preferred embodiments, the breading composition comprises a main starch component and the main starch component comprises from 10%-60% n-OSA starch, 0%-20% cook-up starch, and 30%-90% pre-gelatinized starch. In other preferred embodiments, the breading composition comprises a main starch component and the main starch component comprises from 14.64%-50% n-OSA starch, 0%-15% cook-up starch, and 37.5%-72.86% pre-gelatinized starch. In yet other preferred embodiments, the breading composition comprises a main starch component and the main starch component comprises from 14.64%-50% n-OSA starch, 0%-12.5% cook-up starch, and 37.5%-72.86% pre-gelatinized starch.

The water application step of the present invention can comprise spraying the food product with water, misting by applying a fine spray mist of water, manual or automatic steam injection, manually or automatically applying water to the food product, or combinations thereof. The baking step can include any number of baking processes to bake the food product, including: in an oven, convection oven, conventional oven, stove, microwave, grill, steamer, smoker, rotisserie, toaster oven, wood-fired oven, steam injection oven, AGA cooker, pressure cooker, or combinations thereof. In one embodiment, the method for producing a baked product that imparts fried food properties comprises: at least partially coating a food product with an oil product, adding a breading composition to the food product, and baking the food product in a steam injection oven. The steam injection oven allows the application of water to the food product at the same time it is baked. One such steam injection oven available is the OES-10.10 Convotherm® combi oven steamer from Manitowoc Foodservice.

In one embodiment, the process additionally includes the step of freezing the food product. The food product can be frozen at any convenient point in the process, including after the food product has been combined with the oil product and the breading composition. In another embodiment, the freezing step can occur after the food product has been combined with the oil product, the breading composition, or after application of water to the food product. The frozen food product can then be baked at a later time when convenient. If the freezing step occurs before the water application step, water is applied to the food product prior to baking. In another embodiment, the frozen food product is partially or completely thawed prior to the baking step.

In another embodiment, the method for producing a baked product that imparts a fried food appearance, texture, and/or flavor comprises: providing an initial breading mixture to a food product, at least partially coating a food product with an oil product, adding an additional breading composition to the food product, applying water to the food product, and baking the food product. This process allows an additional layer of breading to be added to the food product.

In one embodiment, the process includes a method of producing a frozen product for baking that imparts a fried food appearance, comprising: at least partially coating an oil product to a food product, adding a breading composition to the food product, and freezing the food product. In another embodiment, water is applied to the food product, which is then frozen. The frozen food product can then be baked at a later time when convenient. In one embodiment, the frozen food product can be partially or completely thawed prior to baking.

### EXAMPLES

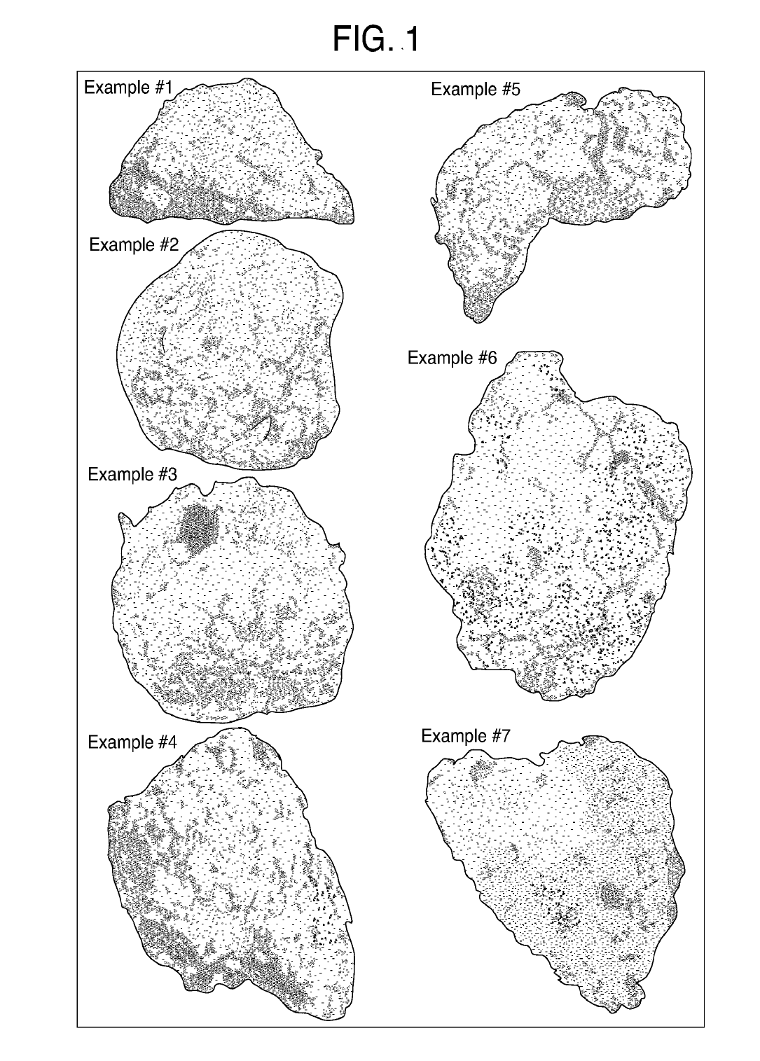

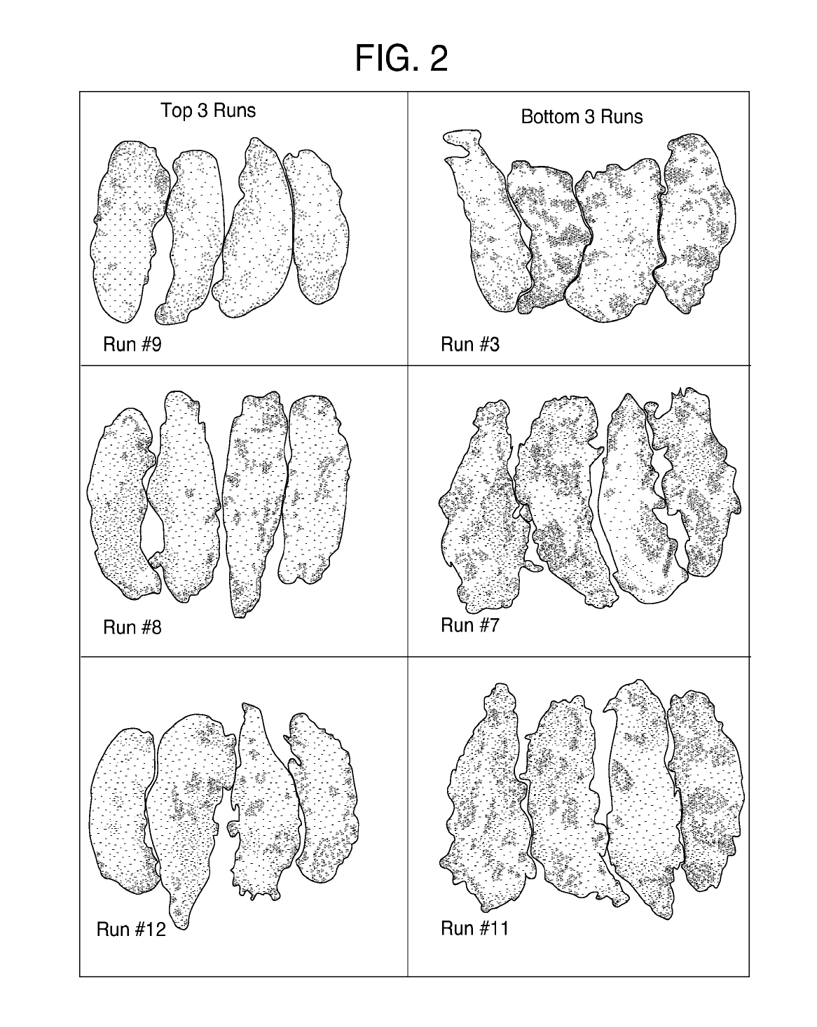

Aspects of certain methods, in accordance with aspects of the invention, are illustrated in the following examples. In these examples, the process provides for producing a baked food product that offers the benefits of a fried food without the detriments that accompany frying it in oil. In these examples, the food product is raw chicken, as it is a good example of a common food product fried in oil. The food products are cooked in a steam injection oven, specifically, a Convotherm® combi oven steamer, which is available from Manitowoc Foodservice. After the food product is at least partially coated in an oil product and combined with a breading composition, the food product is baked with water manually added as steam. This oven allows the food product to be baked while steam is added to the product all in one step. FIG. 1 shows the baked food products according to examples 1-7. FIG. 2 shows the top 3 (best) and bottom 3 (worst) runs from example 8.

### Example #1

In Example #1, a chicken breast that is prepared using breading formula #1 is baked in a steam injection oven that is pre-heated to 416° F. with hot air, and then it is set at 375° F. combi setting C&T1 (the “Crisp & Tasty” setting of 1, which is the lowest of three settings). Steam is injected manually. The probe indicates a temperature of 167° F. Total cooking time is 18 minutes and 39 seconds.

The resulting baked product has meat that is very juicy, with no gray burnt ends and a good fried food appearance. The bottom was still wet after sitting for about 10 minutes. Overall good quality to the product.

### Example #2

The second example is a chicken breast prepared using breading formula #2 that is baked in a steam injection oven that is pre-heated to 416° F. with hot air, and then it is set at 375° F. (combi, with no C&T setting). Steam is injected manually. The probe indicates a temperature of 167° F. Total cooking time for the food product is 19 minutes and 56 seconds.

The resulting baked food product has a wet bottom coming out of the oven. Oven performance had some issues, but the product has great color and also a good crust after resting for seven minutes.

### Example #3

The third example is a chicken breast that is prepared using breading formula #2 that is baked in a steam injection oven pre-heated to 416° F. with hot air, and then it is set at 375° F. combi setting C&T2 (the second, or medium, setting) for nine minutes. Steam is injected manually. Total cooking time is 18 minutes.

The baked product from example #3 has overall good appearance and color, although it does have a dark knob.

### Example #4

The fourth example is a chicken breast that is prepared using breading formula #2 that is baked in a steam injection oven pre-heated to 425° F. with hot air, and then set at 375° F. combi for five minutes. Steam is injected manually. It is then set at 375° F. combi setting C&T1 (low) for 17 minutes and 16 seconds for baking. Total cooking time is 18 minutes.

The baked product has the best bottom crust of the examples. It is a bit dry looking coming out of the oven but does have good color and good overall fried appearance.

### Example #5

The fifth example is a chicken breast that is prepared using breading formula #2, baked in a steam injection oven that is pre-heated to 416° F. with hot air, and then is set at 375° F. combi setting C&T1 (low setting). Steam is injected manually. The probe indicates a temperature of 167° F. Total cooking time is 18 minutes and 30 seconds.

The baked product is dry looking coming out of the oven with some gray burnt knobs, although the oven was not injecting steam.

### Example #6

The sixth example is a chicken breast that is prepared using breading formula #2, baked in a steam injection oven that is pre-heated to 400° F. with hot air, and then is set at 375° F. combi setting C&T1 (low setting). Steam is injected manually. The probe indicates a temperature of 167° F. Total cooking time is 18 minutes and 40 seconds.

Similar to example #5, the baked product is dry looking coming out of the oven with some gray burnt knobs, as the oven was not injecting steam.

### Example #7

The seventh example is a chicken breast that is prepared using breading formula #2, baked in a steam injection oven that is pre-heated to 425° F. with hot air, and then is set at 375° F. combi setting C&T1 (low setting) for five minutes. Steam is injected manually. It is then set at 375° F. combi setting C&T1 (low setting) for 13 minutes and 30 seconds. The probe indicates a temperature of 167° F. Total cooking time is 18 minutes and 30 seconds.

The baked product has good kerneling on the crust and some dark knobs, but a good crust and good overall appearance of fried chicken.

Below is Table #1, containing information on breading formula #1 and with information on the optional spice blend added to the breading composition.

TABLE #1

| | % (for mix w/out | total % (with |
|---|---|---|
| Ingredients (for mix) | oil and spices) | oil and spices) |
| Emtex 12688 (n-OSA starch) | 42.0% | 40.47% |
| Pregel Wheat Starch | 32.5% | 31.32% |
| Yellow corn meal | 4.9% | 4.72% |
| Maltodextrin MD01901 | 9.2% | 8.86% |
| Maillose | 1.0% | 0.96% |
| Buttermilk powder | 3.3% | 3.18% |
| Salt (tote) | 2.0% | 1.93% |
| Sodium bicarbonate E500 | 2.1% | 2.02% |
| Calcium phosphate mono | 0.6% | 0.58% |
| basic (anhydrous) E341 | | |
| Sodium acid pyrophosphate | 1.4% | 1.35% |
| E339 SAPP 37 | | |
| Total (for mix) | 100% | |
| Added spices (see below) | | 1.72% |
| Canola Oil | | 2.89% |
| Total size of batch (with | | 100% |
| oil and spices) | | |

Added Spices
(Amounts based on ~150 g mix)
1 g onion powder
0.5 g garlic powder
0.2 g white pepper
0.7 g celery salt
0.3 g black pepper

Below in Table #2 is information on breading formula #2, which is the formula used for Examples #2-#7. The supplier for each of the ingredients is listed.

TABLE #2

| Dry Mix | Supplier: | Lot #: | % | mass (g) |
|---|---|---|---|---|
| C*EmTex 12688 | Cargill | 01225320 | 38.23% | 442.4 |
| (n-OSA starch) | | | | |
| Pregel Wheat | ADM | 100465-30171 | 29.58% | 342.3 |
| Starch, Aytex | | | | |
| Maltodextrin, | Cargill | R0A086-P | 8.37% | 96.9 |
| MD01901I | | | | |
| Canola Oil, | Cargill | 110865CV65/ | 8.26% | 95.6 |
| CV65 | | 111005CV65 | | |
| Yellow Corn | Cargill | P1105-E | 4.46% | 51.6 |
| Meal | | | | |
| Buttermilk | Retail | | 3.01% | 34.8 |
| Powder | | | | |
| Sodium Bi- | Retail | | 1.91% | 22.1 |
| carbonate | | | | |
| Salt | Cargill | H2171 15:41 | 1.82% | 21.1 |
| SAPP 40 | ICL | 223043136 | 1.27% | 14.7 |
| (sodium acid | | | | |
| pyrophosphate) | | | | |
| Maillose | Red | 04061529 | 0.91% | 10.5 |
| | Arrow | | | |
| MCP, 12xx | Innophos | 1879 | 0.55% | 6.4 |
| (monocalcium | | | | |
| phosphate) | | | | |
| Spice Blend | | | 1.63% | 18.9 |
| (optional) | | | | |
| Onion Powder | Retail | | 0.604% | 7.0 |
| Celery Salt | Retail | | 0.422% | 4.9 |
| Garlic Powder | Retail | | 0.302% | 3.5 |
| Black Pepper | Retail | | 0.181% | 2.1 |
| White Pepper | Retail | | 0.121% | 1.4 |
| | | | 100.00% | 1157.2 |

The breading composition is prepared by mixing the dry ingredients in a mixer bowl. The oil is added while mixing on low (setting 1) for one minute, continuing to mix on low (setting 1) for a total of five minutes. The bowl and paddle is scraped down, and then mixed on low (setting 1) for five minutes.

### Example #8

### Experimental Design

The experimental design for this example was structured to test the main starch component of the breading composition. The focus of the design was placed on four main variables: n-OSA starch %, cook-up starch %, pregel starch %, and n-OSA starch viscosity. Table 3 shows the ingredients which make up the breading compositions for this example.

TABLE #3
Coating (Breading Composition) Formulation
for Experimental Design

| Ingredient | Supplier | Lot # | True % |
|---|---|---|---|
| n-OSA Starch | | | Individually |
| Low Viscosity - 12674 | Cargill | R1Y014A | variable by |
| Med Viscosity - 12633 | Cargill | R2J104P | run; but total |
| High Viscosity - 12688 | Cargill | 01292867 | combined |
| Pregel Corn Starch - 12030 | Cargill | H0N402; | content of |
| | | H2G059 | 76.115% |
| Cook-up Starch | | | |
| 75% Batter Crisp ™ 90240 | Cargill | H1G267 | |
| 25% Rice Flour | Gulf Pacific | G17215LGW- | |
| | | 41122 | |
| Canola Oil - CV65 | Cargill | 12282SCV65 | 9.271% |
| Yellow Corn Meal | Cargill | P13098-F | 5.008% |
| Buttermilk Powder | Retail | 12353-2 | 3.380% |
| Baking Soda | AB Mauri | NS111212 | 2.146% |
| Salt | Cargill | 24B12ACVAA | 2.040% |
| SAPP43 - Perfection | Innophos | 130916 | 1.423% |
| (sodium acid pyrophos- | | | |
| phate) | | | |
| MCP - V90 (monocalcium | Innophos | 152277 | 0.617% |
| phosphate) | | | |
| TOTAL | | | 100.000% |

As seen in table 3, the combination of n-OSA starch, pregel starch, and cook-up starch (main starch component) make up 76.115% of the breading composition. Twenty-seven runs were conducted, each with varying ratios of n-OSA starch, pregel starch, and cook-up starch. The viscosity of the n-OSA starch was also varied.

Table 4, below, shows the ratios of the 3 components which make up the main starch component, as well as the viscosity of the n-OSA starch for each of the 27 runs conducted in this example. Table 4 also shows the average response to each of the 4 sensory qualities which were assessed: crispiness, toothpack, aftertaste, and gray nubs.

TABLE #4

| | Design Factors | | | | Response Scores | | | |
|---|---|---|---|---|---|---|---|---|
| | Factor 1 | Factor 2 | Factor 3 | Factor 4 | Resp 1 | Resp 2 | Resp 3 | Resp 4 |
| Run | n-OSA % | Cook-up % | Pregel % | n-OSAᵥ | Crispiness | Toothpack | Aftertaste | Gray Nubs |
| 1 | 25.00 | 25.00 | 50.00 | M - 12633 | 2.3 | 3.0 | 0.7 | 2.3 |
| 2 | 75.00 | 0.00 | 25.00 | L - 12674 | 1.3 | 2.7 | 2.7 | 1.7 |
| 3 | 75.00 | 25.00 | 0.00 | L - 12674 | 0.3 | 2.0 | 3.0 | 0.7 |
| 4 | 25.00 | 25.00 | 50.00 | H - 12688 | 2.0 | 1.7 | 0.7 | 1.3 |
| 5 | 50.00 | 30.18 | 19.82 | M - 12633 | 2.3 | 2.0 | 1.3 | 2.0 |
| 6 | 50.00 | 12.50 | 37.50 | M - 12633 | 3.7 | 2.3 | 1.3 | 2.7 |
| 7 | 85.36 | 12.50 | 2.14 | L - 12674 | 0.7 | 1.3 | 1.7 | 1.7 |
| 8 | 25.00 | 0.00 | 75.00 | H - 12688 | 3.0 | 1.0 | 0.7 | 0.7 |
| 9 | 14.64 | 12.50 | 72.86 | L - 12674 | 3.7 | 1.3 | 0.7 | 0.7 |
| 10 | 50.00 | 30.18 | 19.82 | H - 12688 | 3.0 | 1.7 | 1.0 | 1.7 |
| 11 | 75.00 | 25.00 | 0.00 | M - 12633 | 1.0 | 3.3 | 1.7 | 1.3 |
| 12 | 50.00 | 0.00 | 50.00 | H - 12688 | 3.0 | 1.7 | 1.0 | 0.7 |
| 13 | 75.00 | 0.00 | 25.00 | H - 12688 | 2.3 | 2.7 | 0.3 | 1.7 |
| 14 | 25.00 | 0.00 | 75.00 | M - 12633 | 3.7 | 2.7 | 1.0 | 2.7 |
| 15 | 50.00 | 12.50 | 37.50 | L - 12674 | 1.3 | 2.3 | 1.0 | 0.3 |
| 16 | 14.64 | 12.50 | 72.86 | H - 12688 | 3.0 | 1.0 | 0.7 | 2.0 |
| 17 | 50.00 | 0.00 | 50.00 | M - 12633 | 3.3 | 3.0 | 1.7 | 2.0 |
| 18 | 85.36 | 12.50 | 2.14 | H - 12688 | 2.0 | 1.7 | 1.0 | 0.7 |
| 19 | 25.00 | 0.00 | 75.00 | L - 12674 | 2,7 | 2.3 | 0.7 | 1.3 |
| 20 | 25.00 | 25.00 | 50.00 | L - 12674 | 2.7 | 1.7 | 0.7 | 1.3 |
| 21 | 75.00 | 25.00 | 0.00 | H - 12688 | 1.7 | 2.3 | 0.7 | 1.0 |
| 22 | 85.36 | 12.50 | 2.14 | M - 12633 | 2.3 | 1.0 | 2.0 | 1.0 |
| 23 | 50.00 | 30.18 | 19.82 | L - 12674 | 1.7 | 1.7 | 1.3 | 1.0 |
| 24 | 50.00 | 0.00 | 50.00 | L - 12674 | 1.0 | 1.7 | 0.7 | 0.7 |
| 25 | 75.00 | 0.00 | 25.00 | M - 12633 | 1.7 | 1.7 | 0.7 | 1.7 |
| 26 | 14.64 | 12.50 | 72.86 | M - 12633 | 1.3 | 1.3 | 0.3 | 2.0 |
| 27 | 50.00 | 12.50 | 37.50 | H - 12688 | 1.0 | 1.3 | 0.3 | 0.7 |

n-OSAᵥ = n-OSA viscosity (L = Low, M = Medium, H = High)

The n-OSA viscosity was varied by sourcing three separate n-OSA starches, one each at low, medium, and high viscosities. In examples 1-7, only one n-OSA viscosity was utilized—Cargill C*EmTex 12688, which has a high viscosity (it should be noted that all n-OSA starches, in general, are lower in viscosity relative to other starches, but there does exist a distinction within the n-OSA category). The Cargill 12688 (˜4000-6000 cP, 30% dry solids @ 25° C.) was retained as the high viscosity option. Cargill 12633 (˜1000-3000 cP) was chosen for medium viscosity, and Cargill 12674 (˜25-150 cP) was selected for the low viscosity n-OSA starch.

All runs were conducted under the same processing parameters, but were completed over three separate days. Four boneless, skinless chicken tenders were used for each run. The tenders were allowed to rest for ˜10-20 minutes at room temperature after being removed from refrigeration. After resting, the tenders were dipped in a heated (liquefied) oil blend. This blend consisted of 50% palm oil (˜100° F. melt point), 25% palm/soy oil blend (˜102° F. melt point), and 25% high-oleic canola oil (all 3 oils are trans fat-free). This blend was designed to mimic a standard commercial fryer oil. Once each tender had been submerged in oil, it was removed and allowed to briefly drain before being placed in the coating (breading composition) mixture. Coating was pressed onto each side, flipping each tender so that each side was pressed twice. Coated tenders were then placed onto baking racks, where they were sprayed/misted with water using a hand-operated (trigger) spray bottle. Each side of the tender was sprayed with ˜4-8 squeezes, depending on the amount required to sufficiently moisten the coating. After spraying, samples had ˜2-4 minutes of floor time while waiting for the Convotherm® oven to reach temperature. Once the oven was at temperature, samples were placed into the oven (2 racks at a time, 1 run per rack, 4 tenders per run) and baked for 13 minutes at 390° F. (Combi setting—steam and convection, with Crisp & Tasty setting #2). An additional burst of steam was added manually for each sample after the product had been in the oven for 30 seconds. When baking was complete, samples were removed from the oven and then moved from the baking racks to cooling racks. Samples were allowed to cool ˜10 minutes before they were distributed for sensory analysis.

The responses that were chosen for the experimental design are as follows (see Table 4): Crispiness, Toothpack, Aftertaste, and Gray Nubs (the nubs tend to form when excess coating clumps together and then bakes to a visually unappealing gray color). The first three responses are all perceived texture/taste characteristics; the final, Gray Nubs, is a perceived visual characteristic. These parameters were all scored on a 0-5 scale, with a score of “0” meaning this attribute was absent, and a score of 1-5 meaning that the attribute was present (“1” being low and “5” being high). For crispiness, the desired outcome was to score as high as possible to maximize this trait. For the remaining three responses, the desired outcome would be to score as low as possible, or minimizing those traits.

Results were gathered via sensory testing within the lab. Each run was sampled by 3 different individuals, and thus 3 data points were obtained for each characteristic for each run. Two individuals sampled all 27 runs. For the third data point, one individual sampled the first 14 runs, but a second individual sampled the last 13 runs. Scores were recorded and averaged. The average scores for each characteristic for each run can be seen in table 4.

The top five scoring runs for each specific response were isolated. Table 5 shows the top 5 runs for each response. In addition to the four specific responses (Crispiness, Toothpack, Aftertaste, and Gray Nubs), one additional range of data was assembled. This is referred to as the ‘TAG Average’, which consists of the top five runs that had the lowest combined average scores for Toothpack, Aftertaste, and Gray Nubs.

TABLE #5
Top 5 Runs for each Specific Trait

| | #1 | | #2 | | #3 | | #4 | | #5 | |
|---|---|---|---|---|---|---|---|---|---|---|
| Trait | Run # | n-OSAᵥ | Run # | n-OSAᵥ | Run # | n-OSAᵥ | Run # | n-OSAᵥ | Run # | n-OSAᵥ |
| Crispiness | 9 | L | 14 | M | 6 | M | 17 | M | 8 | H |
| Toothpack | 8 | H | 16 | H | 22 | M | 9 | L | 27 | H |
| Aftertaste | 13 | H | 27 | H | 26 | M | 9 | L | 8 | H |
| Gray Nubs | 15 | L | 9 | L | 8 | H | 12 | H | 18 | H |
| TAG Avg¹ | 8 | H | 27 | H | 9 | L | 24 | L | 12 | H |

n-OSAᵥ = n OSA viscosity (L = Low, M = Medium, H = High)
¹Based on the 5 runs that had the lowest combined average scores for Toothpack, Aftertaste, and Gray Nubs

Crispiness is typically considered to be the most important trait. It was surprisingly discovered that utilizing the process of the present invention with a particular ratio of n-OSA starch, cook-up starch, and pre-gelatinized starch yielded baked products with superior crispiness. It was also quite unexpected that the same particular ratio of n-OSA starch, cook-up starch, and pre-gelatinized starch yielded baked products with the best TAG Avg.

Thus, the same blend of n-OSA starch, cook-up starch, and pre-gelatinized starch which can be used in the present invention to produce baked products with good crispiness also yields a product with low toothpack, aftertaste, and gray nubs.

The particular embodiments disclosed above are illustrative only, as the present disclosure can be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above can be altered or modified and all such variations are considered within the scope and spirit of the present disclosure.

We claim:

1. A method for producing a baked product that imparts fried food properties, comprising:
a. At least partially coating a food product with an oil product;
b. Adding a breading composition to the food product;
c. Applying water to the food product; and
d. Baking the food product to produce a baked product.

2. The method of claim 1, wherein the oil product comprises an oil, a fat, a water in oil emulsion, olean, mono and diglycerides, or combinations thereof.

3. The method of claim 1, wherein the breading composition comprises a pre-gelatinized starch, a glucose polymer, or combinations thereof.

4. The method of claim 1, wherein the breading composition comprises a main starch component and the main starch component comprises from 10%-60% n-OSA starch, 0%-20% cook-up starch, and 30%-90% pre-gelatinized starch.

5. The method of claim 1, wherein the breading composition comprises a main starch component and the main starch component comprises from 14.64%-50% n-OSA starch, 0%-12.5% cook-up starch, and 37.5%-72.86% pre-gelatinized starch.

6. The method of claim 1, wherein the water application step comprises manually or automatically spraying, misting, steam injection, or combinations thereof.

7. The method of claim 1, wherein the baking step comprises baking the breaded food product in an oven, convection oven, conventional oven, stove, microwave, grill, steamer, smoker, rotisserie, toaster oven, wood-fired oven, steam injection oven, AGA cooker, pressure cooker, or combinations thereof.

8. The method of claim 1, further comprising adding the breading composition prior to adding the oil product and after adding the oil product.

9. A method for producing a baked product that imparts a fried food appearance, texture and/or flavor, comprising:
a. At least partially coating an oil product to the food product;
b. Combining a breading composition with the food product; and
c. Baking the breaded food product in a steam injection oven to produce a baked product.

10. The method of claim 9, wherein the oil product comprises an oil, a fat, a water in oil emulsion, olean, mono and diglycerides, or combinations thereof.

11. The method of claim 9, wherein the breading composition comprises a pre-gelatinized starch, a glucose polymer, or combinations thereof.

12. The method of claim 9, wherein the breading composition comprises a main starch component and the main starch component comprises from 14.64%-50% n-OSA starch, 0%-12.5% cook-up starch, and 37.5%-72.86% pre-gelatinized starch.

13. A method for producing a frozen food product for baking that imparts fried food properties, comprising:
a. At least partially coating a food product with an oil product;
b. Adding a breading composition to the food product; and
c. Freezing the food product.

14. The method of claim 13, further comprising applying water to the food product.

15. The method of claim 14, further comprising thawing the food product.

16. The method of claim 15, further comprising baking the food product.

17. The method of claim 13, wherein the oil product comprises an oil, a fat, a water in oil emulsion, olean, mono and diglycerides, or combinations thereof.

18. The method of claim 13, wherein the breading composition comprises a pre-gelatinized starch, a glucose polymer, or combinations thereof.

19. The method of claim 13, wherein the breading composition comprises a main starch component and the main starch component comprises from 14.64%-50% n-OSA starch, 0%-12.5% cook-up starch, and 37.5%-72.86% pre-gelatinized starch.

20. The method of claim 13, wherein the water application step comprises manually or automatically spraying, misting, steam injection, or combinations thereof.

21. The method of claim 13, wherein the baking step comprises baking the breaded food product in an oven, convection oven, conventional oven, stove, microwave, grill, steamer, smoker, rotisserie, toaster oven, wood-fired oven, steam injection oven, AGA cooker, pressure cooker, or combinations thereof.
